(19) United States
(12) Patent Application Publication
(10) Pub. No.: US 2026/0180411 A1
(43) Pub. Date: Jun. 25, 2026

(54) ELECTRIC DRIVE DEVICE, ASSEMBLING METHOD THEREOF, AND WIRING STRUCTURE OF ELECTRIC DEVICE

(71) Applicant: HONDA MOTOR CO., LTD., Tokyo (JP)

(72) Inventors: Takeki KISHI, Saitama (JP); Kosuke NISHIYAMA, Saitama (JP); Hideaki SAKAI, Saitama (JP)

(21) Appl. No.: 19/358,752

(22) Filed: Oct. 15, 2025

(30) Foreign Application Priority Data
Dec. 19, 2024 (JP) 2024-223923

(51) Int. Cl. H02K 11/33; B64D 31/16

(52) U.S. Cl. CPC H02K 11/33; B64D 31/16

(57) ABSTRACT

An electric drive device includes an electric motor, and a controller configured to control the electric motor. The electric motor includes a stator, and an electrically connected member electrically connected to the stator. The electrically connected member is fastened to the controller, and when the electric drive device is viewed in an axial direction of the electric motor, a fastening portion between the electrically connected member and the controller is arranged inside the electric drive device and does not overlap with the stator.

### TECHNICAL FIELD

The present invention relates to an electric drive device, an assembling method of the electric drive device, and a wiring structure of an electric device.

### BACKGROUND ART

In recent years, efforts to realize a low-carbon or carbon-free society have been gaining momentum, and research and development of electrification technologies is being conducted for vehicles, aircraft, and the like to reduce CO2 emissions and improve energy efficiency.

As one aspect of research and development in electrification technologies, research and development of the electric drive devices is being conducted. For example, JP2023-048078A discloses a motor device unit (drive device) including a motor device and an inverter device. The motor device includes an intermediate terminal that is connected to the inverter device.

As shown in FIG. 3 of JP2023-048078A, when viewed in the axial direction of the motor device, the intermediate terminal is arranged so as to overlap with a stator. Accordingly, when adopting a configuration in which the intermediate terminal is fastened to the inverter device along an axial direction of the motor device, it becomes difficult to secure a space through which a tool for fastening the intermediate terminal to the inverter device can be passed. This may result in a decrease in the workability of assembling the motor device unit.

### SUMMARY OF THE INVENTION

In view of the above background, an object of the present invention is to easily secure a space through which a tool can be passed, and improve the workability of assembling an electric drive device and an electric device. This in turn contributes to improving the energy efficiency.

To achieve such an object, one aspect of the present invention provides an electric drive device including an electric motor, and a controller that controls the electric motor. The electric motor includes a stator, and at least one electrically connected member electrically connected to the stator. The electrically connected member is fastened to the controller, and when the electric drive device is viewed in an axial direction of the electric motor, a fastening portion between the electrically connected member and the controller is arranged inside the electric drive device and does not overlap with the stator.

Another aspect of the present invention is an assembling method of an electric drive device, the electric drive device including an electric motor including a stator, a rotor rotatable relative to the stator, and an electrically connected member electrically connected to the stator, and a controller that controls the electric motor. The assembling method includes the sequential processes of attaching the stator to the controller, fastening the electrically connected member to the controller, and arranging the rotor to face the stator. In the fastening process, when the electric drive device is viewed in an axial direction of the electric motor, the electrically connected member is fastened to the controller on an inner side of an inner circumferential surface of the stator.

Another aspect of the present invention is a wiring structure of an electric device, the wiring structure including a tubular member extending in an axial direction, an electrically connected member electrically connected to the tubular member, and a member to be fastened to the electrically connected member, and when the electric device is viewed in the axial direction, a fastening portion between the electrically connected member and the member to be fastened is arranged inside the electric device and does not overlap with the tubular member.

Thus, according to the above aspects, it is possible to easily secure a space through which the tool can be passed, and improve the workability of assembling the electric drive device and the electric device.

### BRIEF DESCRIPTION OF THE DRAWING(S)

FIG. 1 is a perspective view of an aircraft according to an embodiment;

FIG. 2 is a partial cross-sectional view showing a propulsion unit according to the embodiment;

FIG. 3 is a perspective view showing a propulsion drive device according to the embodiment;

FIG. 4 is an exploded perspective view showing the propulsion drive device according to the embodiment;

FIG. 5 is a cross-sectional view showing the propulsion drive device according to the embodiment;

FIG. 6 is a front view showing a controller according to the embodiment;

FIG. 7 is a front view showing a smoothing capacitor and its circumference according to the embodiment;

FIG. 8 is a perspective view showing fixing structures of power modules according to the embodiment;

FIG. 9 is a circuit diagram showing a DC power supply and the propulsion drive device according to the embodiment;

FIG. 10 is a perspective cross-sectional view showing the smoothing capacitor and its circumference according to the embodiment;

FIG. 11 is a perspective view showing the smoothing capacitor according to the embodiment;

FIG. 12 is a perspective view showing a notch and its circumference according to the embodiment; and

FIG. 13 is a perspective view showing an electric connection structure of the controller according to the embodiment;

FIG. 14 is a cross-sectional view showing a first and second fastening portion and its circumference according to the embodiment;

FIG. 15 is a front view showing a stator and the controller according to the embodiment;

FIG. 16 is a perspective view showing an attaching process according to the embodiment; and

FIG. 17 is a perspective view showing an arranging process according to the embodiment.

### DETAILED DESCRIPTION OF THE INVENTION

### an aircraft 1

In the following, an aircraft 1 (an example of a mobile body) according to an embodiment of the present invention will be described with reference to the drawings

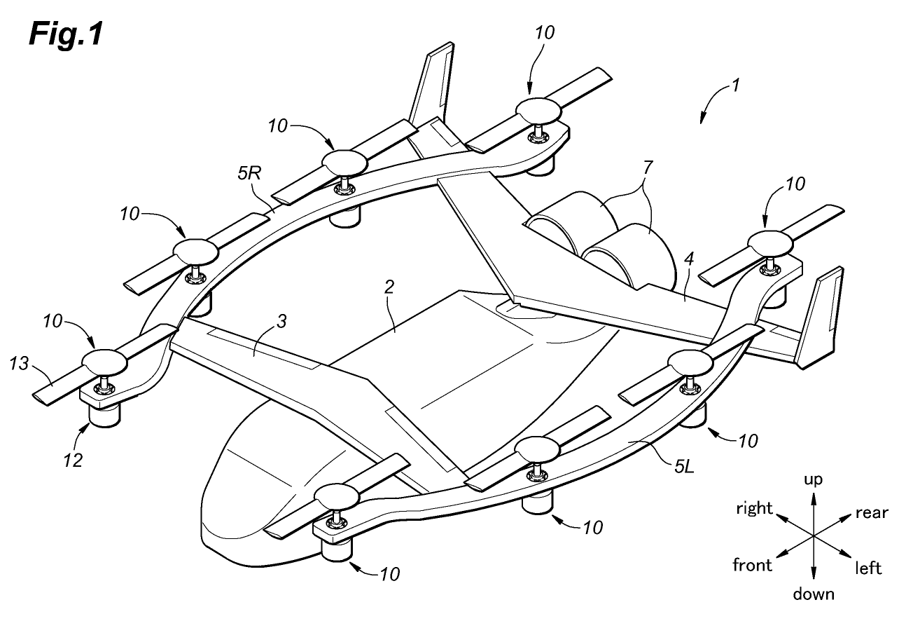

With reference to FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4.

A cabin (not shown) for an occupant to board is provided in the front portion of the body 2. Left and right propulsion units 7 for applying the forward propulsion force to the aircraft 1 are provided at the rear end of the body 2.

The left arm 5L and the right arm 5R are each provided with a plurality of (for example, four) lift units 10 for applying the ascending and descending forces to the aircraft 1. The plurality of lift units 10 is arranged at intervals in the front-and-rear direction. Each lift unit 10 includes a lift drive device 12 and a lift rotor 13 attached to the lift drive device 12. The lift drive device 12 includes an electric motor (not shown), and is configured to rotate the lift rotor 13 by the driving force of the electric motor.

### the propulsion unit 7

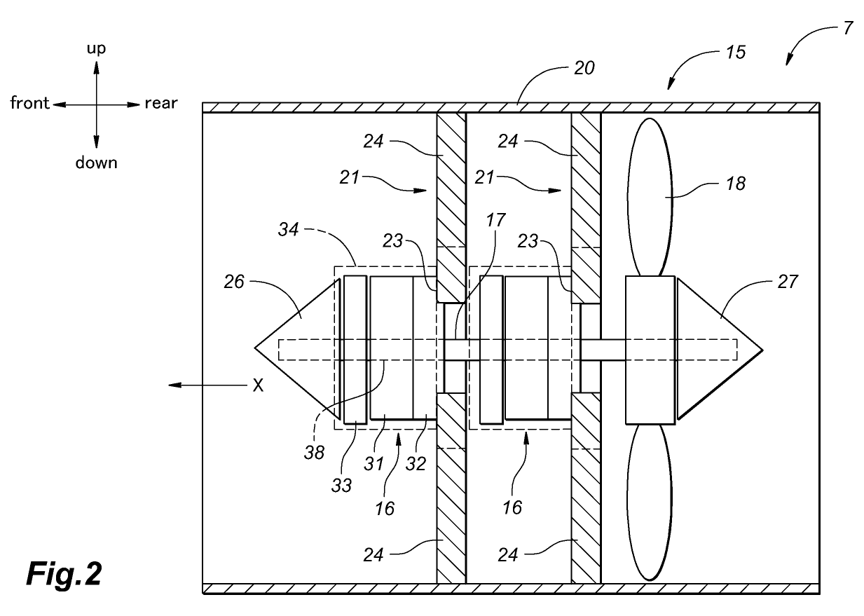

With reference to FIG. 2, each propulsion unit 7 includes a support body 15, front and rear propulsion drive devices 16 (an example of an electric drive device and an electric device) supported by the support body 15, a rotation shaft 17 extending in the front-and-rear direction and rotatably supported by the front and rear propulsion drive devices 16, and a propulsion rotor 18 fixed to the rear portion of the rotation shaft 17.

The support body 15 is fixed to the rear end of the body 2 (see FIG. 1). The support body 15 includes a cylindrical nacelle 20 extending in the front-and-rear direction, and front and rear mount frames 21 fixed to the inner circumferential surface of the nacelle 20. Each mount frame 21 includes an annular hub 23 that is concentric with the nacelle 20, and a plurality of spokes 24 extending radially from the outer circumferential surface of the hub 23 and connected to the inner circumferential surface of the nacelle 20.

The front and rear propulsion drive devices 16 are accommodated in the nacelle 20. The front and rear propulsion drive devices 16 are fixed to the front surface of the hub 23 of the front and rear mount frames 21, respectively. The details of each propulsion drive device 16 will be described later.

The rotation shaft 17 is accommodated in the nacelle 20. The rotation shaft 17 penetrates through the hub 23 of each mount frame 21. A conical front cover 26 the diameter of which increases toward the rear is fixed to the front end of the rotation shaft 17. The front cover 26 is arranged in front of the front propulsion drive device 16. A conical rear cover 27 the diameter of which increases toward the front is fixed to the rear end of the rotation shaft 17. The rear cover 27 is arranged behind the central portion of the propulsion rotor 18.

The propulsion rotor 18 is accommodated in the nacelle 20. The propulsion rotor 18 is configured to rotate integrally with the rotation shaft 17 according to the rotation of the rotation shaft 17, thereby applying the forward propulsion force to the aircraft 1. the propulsion drive device 16

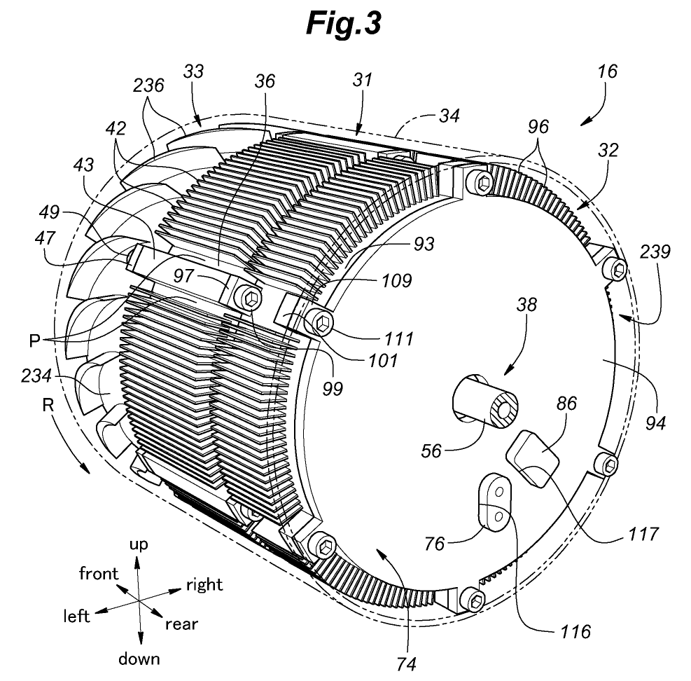

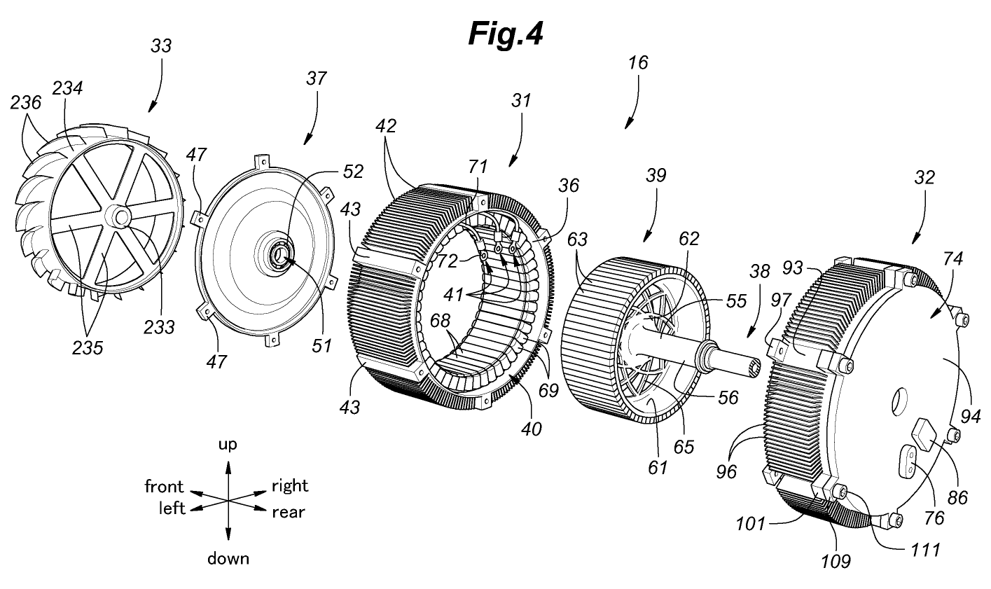

With reference to FIGS. 2 and 3, each propulsion drive device 16 includes an electric motor 31, a controller 32 arranged on the rear side of the electric motor 31, a fan 33 arranged on the front side of the electric motor 31, and a duct cover 34 that covers the outer circumference of the electric motor 31, the controller 32, and the fan 33. In FIG. 4, the duct cover 34 is omitted.

### the electric motor 31

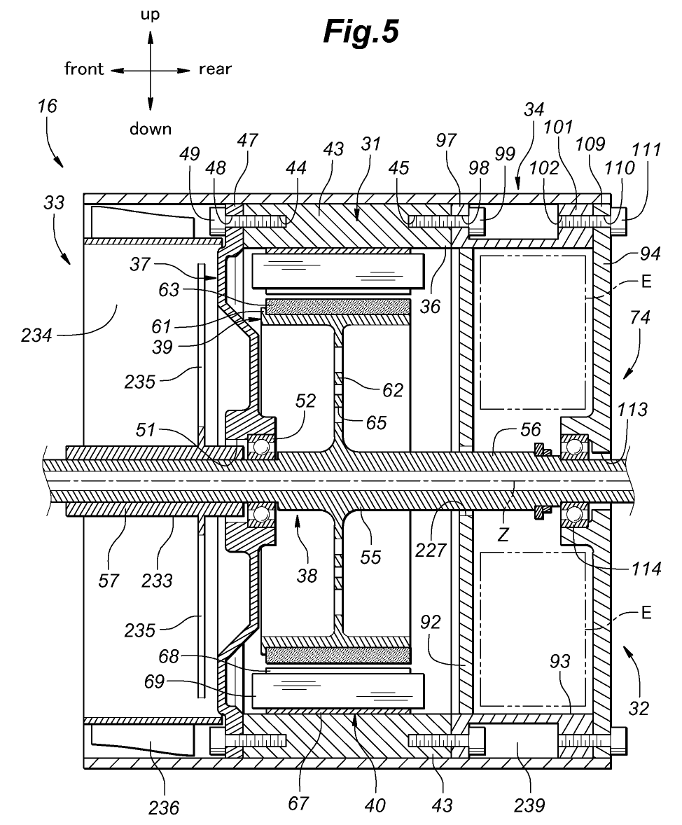

With reference to FIGS. 4 and 5, the electric motor 31 is sandwiched between the controller 32 and the fan 33. For example, the electric motor 31 is a three-phase AC motor of an inner rotor radial gap type. An axis Z of the electric motor 31 extends in the front-and-rear direction. That is, according to the present embodiment, the axial direction of the electric motor 31 is the front-and-rear direction. Hereinafter, the phrase "along the front-and-rear direction" not only means "in a direction parallel in the front-and-rear direction" but also means "in a direction slightly inclined in the front-and-rear direction." The electric motor 31 includes a housing 36, a lid 37, a shaft 38, a rotor 39, a stator 40 (an example of a tubular member), and three electrically connected members 41.

The housing 36 is cylindrical and extends in the front-and-rear direction on the outer circumference of the shaft 38. The housing 36 is arranged on the outer circumference of the rotor 39 and the stator 40 and accommodates the rotor 39 and the stator 40.

A plurality of first cooling fins 42 protrudes from the outer circumferential surface of the housing 36 at intervals in the circumferential direction of the housing 36. The plurality of first cooling fins 42 is formed integrally with the housing 36. Each first cooling fin 42 has a flat plate shape and extends along the front-and-rear direction. Each first cooling fin 42 extends continuously from the front end (one end in the front-and-rear direction) of the housing 36 to the rear end (the other end in the front-and-rear direction) thereof.

A plurality of fastening protrusions 43 protrudes from the outer circumferential surface of the housing 36 at intervals in the circumferential direction of the housing 36. The plurality of fastening protrusions 43 is provided between adjacent first cooling fins 42. Passages P of the cooling air that extend continuously from the front end of the housing 36 to the rear end thereof are formed between the adjacent first cooling fins 42 and each fastening protrusion 43. The plurality of fastening protrusions 43 is formed integrally with the housing 36.

Each fastening protrusion 43 is a rod-shaped portion with a rectangular cross-section and extends along the front-and-rear direction. That is, each fastening protrusion 43 extends parallel to each first cooling fin 42. Each fastening protrusion 43 extends continuously from the front end (one end in the front-and-rear direction) of the housing 36 to the rear end (the other end in the front-and-rear direction) thereof. Each fastening protrusion 43 is integrally formed of the same material from the front end (one end in the front-and-rear direction) of each fastening protrusion 43 to the rear end (the other end in the front-and-rear direction) thereof.

The front end of each fastening protrusion 43 is provided with a first bolt hole 44 for fastening the lid 37 to the housing 36. The rear end of each fastening protrusion 43 is provided with a second bolt hole 45 for fastening a casing 74 of the controller 32 (which will be described later) to the housing 36. The first bolt hole 44 and the second bolt hole 45 extend along the front-and-rear direction.

The lid 37 is adjacent to the housing 36 and closes the opening of the housing 36 on the front side (the side opposite to the controller 32). The lid 37 is a disk-shaped member and extends along a plane perpendicular to the front-and-rear direction. The lid 37 is formed separately from the housing 36. In another embodiment, the lid 37 may be formed integrally with the housing 36.

A plurality of first fastening pieces 47 protrudes from the outer circumferential portion of the lid 37 at intervals in the circumferential direction of the lid 37. Each first fastening piece 47 is provided with a first fastening hole 48 formed in the front-and-rear direction. The lid 37 is fastened to the housing 36 as a first fastening bolt 49 penetrating through the first fastening hole 48 engages with the first bolt hole 44 of each fastening protrusion 43 of the housing 36. A circular first through hole 51 is provided in the front-and-rear direction in the central portion of the lid 37. A first bearing 52 is attached to the first through hole 51.

With reference to FIG. 2, the shaft 38 extends in the front-and-rear direction. The shaft 38 constitutes a portion of the rotation shaft 17 of the propulsion unit 7. Accordingly, as the shaft 38 rotates, the entire rotation shaft 17 rotates, and the propulsion rotor 18 rotates integrally with the rotation shaft 17. This applies the forward propulsion force to the aircraft 1, thereby propelling the aircraft 1 forward. The shaft 38 extends along the propulsion direction of the aircraft 1 (see an arrow X in FIG. 2.

With reference to FIG. 5, the shaft 38 is hollow. The shaft 38 includes a main body 55 accommodated in the housing 36, an extending portion 56 extending from the main body 55 toward the rear side (toward the controller 32), and a protruding portion 57 protruding from the main body 55 toward the front side (the side opposite to the controller 32). The protruding portion 57 penetrates through the first through hole 51 of the lid 37 and extends to the space on the front side of the electric motor 31. The protruding portion 57 is rotatably supported by the lid 37 via the first bearing 52.

With reference to FIGS. 4 and 5, the rotor 39 is hollow. The rotor 39 is provided rotatably relative to the stator 40. The rotor 39 is arranged on the outer circumference of the main body 55 of the shaft 38. The rotor 39 includes a cylindrical rotor core 61 extending in the front-and-rear direction, a rotor plate 62 extending in the radial direction and connecting the main body 55 of the shaft 38 and the rotor core 61, and a plurality of permanent magnets 63 fixed to the outer circumferential surface of the rotor core 61. The rotor core 61 and the rotor plate 62 are formed integrally with the shaft 38. The rotor plate 62 is provided with a plurality of communication holes 65 penetrating therethrough in the front-and-rear direction.

The stator 40 is arranged on the outer circumference of the rotor 39 and faces the rotor 39 at a distance. The stator 40 includes a cylindrical stator core 67 extending in the front-and-rear direction, a plurality of teeth 68 protruding from the inner circumferential surface of the stator core 67, and a plurality of coils 69 wound around the plurality of teeth 68. The stator core 67 is fixed to the inner circumferential surface of the housing 36. Among the components of the electric motor 31 and the controller 32, the plurality of coils 69 has the greatest heat generation. Accordingly, the heat generation of the electric motor 31 is greater than the heat generation of the controller 32.

With reference to FIG. 4, the three electrically connected members 41 are provided at intervals in the circumferential direction. The three electrically connected members 41 correspond to the U-phase, V-phase, and W-phase of the three-phase AC, respectively. Each electrically connected member 41 includes cables 71 electrically connected to the coils 69 and motor bus bars 72 attached to the tip of the cables 71.

### the controller 32

With reference to FIGS. 3 and 4, the controller 32 is integrated with the electric motor 31 and configured to control the electric motor 31. In other words, the propulsion drive device 16 according to the present embodiment is a drive device in which the controller 32 is integrated with the electric motor 31. The controller 32 is electrically connected to the electric motor 31.

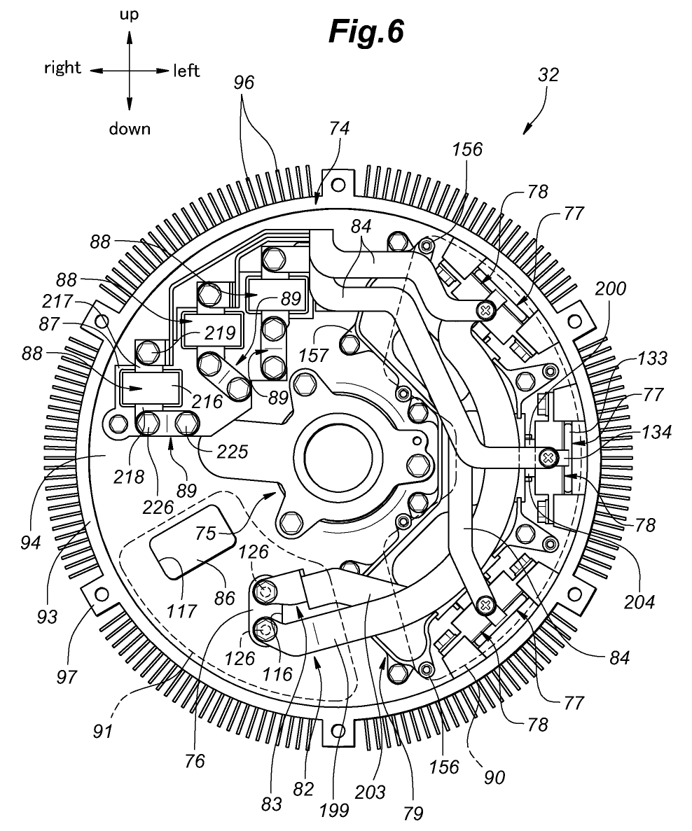

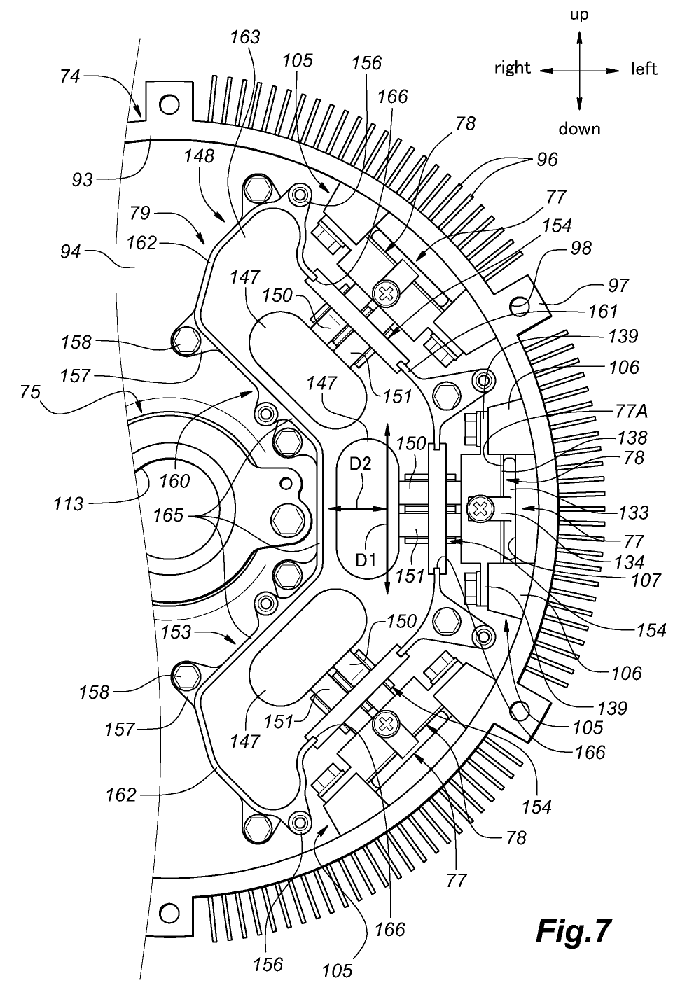

With reference to FIGS. 6 and 7, the controller 32 includes a casing 74, a resolver 75, a DC input connector 76, three power modules 77 (an example of an electronic component), three pressing members 78, a smoothing capacitor 79, first and second DC bus bars 82, 83, three AC bus bars 84, a communication connector 86, a support member 87 (terminal block), three electric current sensors 88 (an example of conductive member), three intermediate bus bars 89 (examples of intermediate members and members to be fastened), a drive board 90 (an example of a circuit board), a control board 91 (an example of a circuit board), and a separating member 92 (see FIG. 5). In FIG. 5, structural components E (for example, the three power modules 77, the smoothing capacitor 79, the three electric current sensors 88, the drive board 90, and the control board 91) of the controller 32 are omitted, and only the outline of the structural components E is shown.

With reference to FIG. 5, the casing 74 is adjacent to the housing 36 of the electric motor 31. The casing 74 is made of metal and has a cylindrical shape with a bottom. The casing 74 accommodates the structural components E of the controller 32.

The casing 74 includes a cylindrical circumferential wall 93 extending in the front-and-rear direction on the outer circumference of the extending portion 56 of the shaft 38, and a bottom wall 94 closing the opening of the circumferential wall 93 on the rear side (the side opposite to the electric motor 31). Hereinafter, the term "circumferential direction" used in the description of the components of the controller 32 will refer to the circumferential direction of the circumferential wall 93 of the casing 74 (in other words, the circumferential direction centered on the extending portion 56 of the shaft 38), and the term "radial direction" used in the description of the components of the controller 32 will refer to the radial direction of the circumferential wall 93 of the casing 74 (in other words, the radial direction centered on the extending portion 56 of the shaft 38.

With reference to FIGS. 3 and 4, a plurality of second cooling fins 96 protrudes from the outer circumferential surface of the circumferential wall 93 of the casing 74 at intervals in the circumferential direction. The plurality of second cooling fins 96 is formed integrally with the circumferential wall 93. Each second cooling fin 96 has a flat plate shape and extends along the front-and-rear direction. Each second cooling fin 96 extends continuously from the front end (one end in the front-and-rear direction) of the circumferential wall 93 to the rear end (the other end in the front-and-rear direction) thereof.

With reference to FIGS. 3 and 5, a plurality of second fastening pieces 97 protrudes at intervals in the circumferential direction from the front end (the end on the side of the electric motor 31) of the outer circumferential surface of the circumferential wall 93 of the casing 74. Each second fastening piece 97 is provided with a second fastening hole 98 formed in the front-and-rear direction. The casing 74 is fastened to the housing 36 as a second fastening bolt 99 penetrating through the second fastening hole 98 engages with the second bolt hole 45 of each fastening protrusion 43 of the housing 36.

A plurality of third fastening pieces 101 protrudes at intervals in the circumferential direction from the rear end (the end opposite to the electric motor 31) of the outer circumferential surface of the circumferential wall 93 of the casing 74. Each third fastening piece 101 is provided with a third fastening hole 102 formed in the front-and-rear direction.

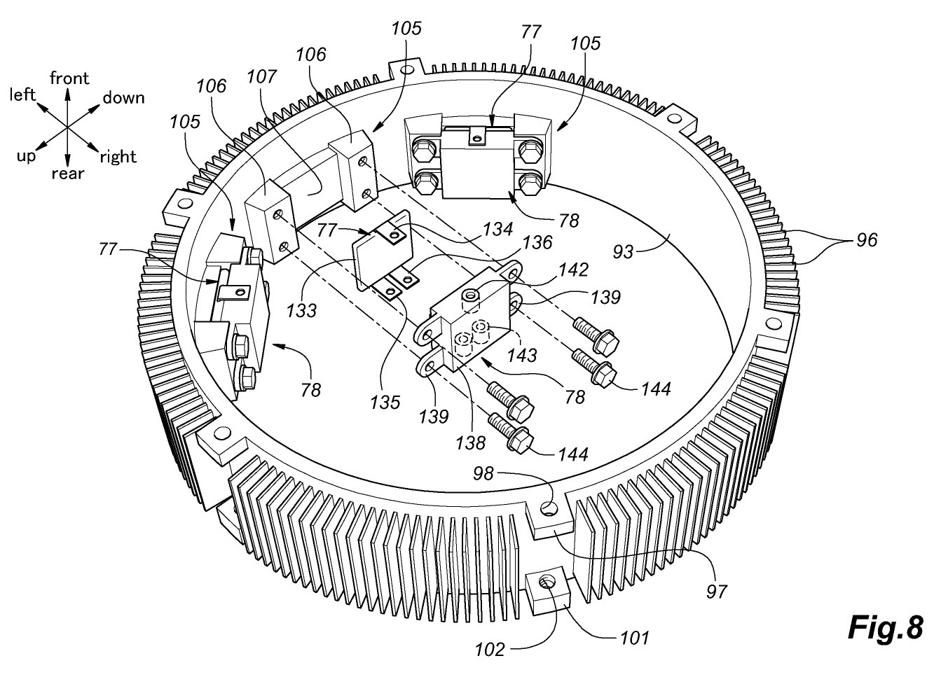

With reference to FIGS. 7 and 8, three pedestals 105 protrude from the inner circumferential surface of the circumferential wall 93 of the casing 74 at intervals in the circumferential direction. A pair of fixing protrusions 106 protrudes from both side portions in the circumferential direction of the inner surface (the inside surface in the radial direction) of each pedestal 105. An engagement recess 107 is provided between the pair of fixing protrusions 106 and in the central portion in the circumferential direction of the inner surface of each pedestal 105.

With reference to FIGS. 5 and 6, the bottom wall 94 of the casing 74 is a disk-shaped portion and extends along a plane perpendicular to the front-and-rear direction. The bottom wall 94 is formed separately from the circumferential wall 93. In another embodiment, the bottom wall 94 may be formed integrally with the circumferential wall 93.

A plurality of fourth fastening pieces 109 protrudes from the outer circumferential portion of the bottom wall 94 of the casing 74 at intervals in the circumferential direction. Each fourth fastening piece 109 is provided with a fourth fastening hole 110 formed in the front-and-rear direction. The bottom wall 94 is fastened to the circumferential wall 93 as a third fastening bolt 111 penetrating through the fourth fastening hole 110 engages with the third fastening hole 102 of each third fastening piece 101 of the circumferential wall 93.

A circular second through hole 113 is provided in the front-and-rear direction in the central portion of the bottom wall 94 of the casing 74. A second bearing 114 is attached to the second through hole 113. The extending portion 56 of the shaft 38 penetrates through the second through hole 113. The extending portion 56 of the shaft 38 is rotatably supported by the second through hole 113 via the second bearing 114. The lower portion of the bottom wall 94 is provided with a first fitting hole 116 and a second fitting hole 117 formed in the front-and-rear direction. The first fitting hole 116 and the second fitting hole 117 are provided at a distance from each other in the circumferential direction.

With reference to FIG. 6, the resolver 75 is fixed to the central portion of the bottom wall 94 of the casing 74. The resolver 75 includes a plurality of detection units (not shown) for detecting the rotation of the extending portion 56 of the shaft 38. The plurality of detection units are arranged at intervals in the circumferential direction.

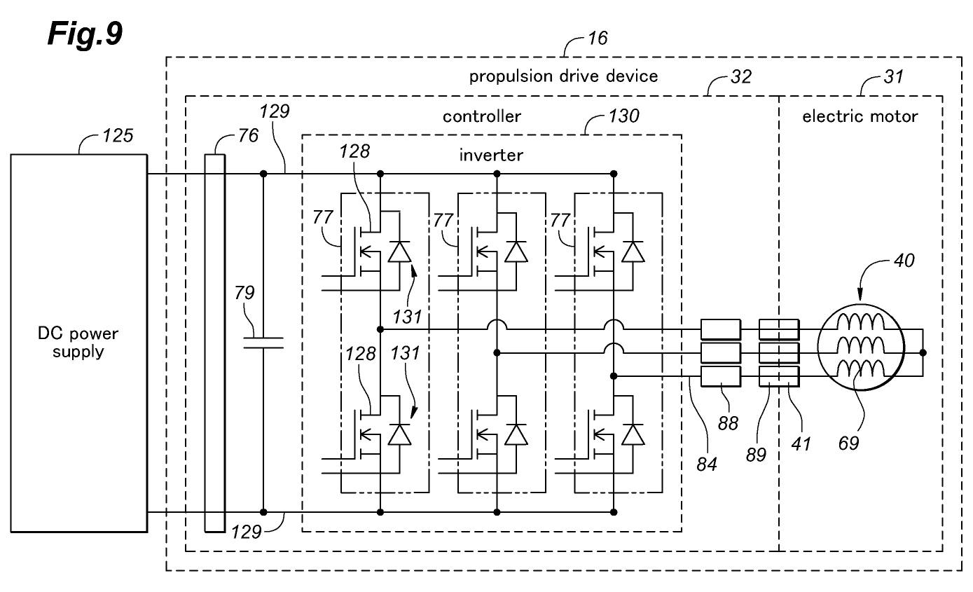

With reference to FIG. 9, the DC input connector 76 is connected to a DC power supply 125 provided outside the propulsion drive device 16. For example, the DC power supply 125 may be composed of a battery or a generator.

With reference to FIGS. 3 and 6, the DC input connector 76 fits into the first fitting hole 116 of the bottom wall 94 of the casing 74 and penetrates through the bottom wall 94 of the casing 74. A pair of DC input terminals 126 is provided on the front surface (the surface on the side of the electric motor 31) of the DC input connector 76.

With reference to FIG. 9, the three power modules 77 each include two switching elements 128. That is, the controller 32 includes a total of six switching elements 128. The six switching elements 128 are components of an inverter 130 (an example of a power conversion circuit) that converts DC power (direct current) input from the DC power supply 125 via a pair of DC lines 129 into AC power (alternating current). Each switching element 128 is composed of a semiconductor element such as an IGBT or a MOSFET. Each switching element 128 is arranged in parallel with a freewheel diode 131.

Each power module 77 is connected to each coil 69 of the stator 40 via each AC bus bar 84, each electric current sensor 88, each intermediate bus bar 89, and each electrically connected member 41. Accordingly, the AC current output from each power module 77 is output to each coil 69 of the stator 40 via each AC bus bar 84, each electric current sensor 88, each intermediate bus bar 89, and each electrically connected member 41.

With reference to FIGS. 7 and 8, the three power modules 77 are arranged at intervals in the circumferential direction and contact with the inner circumferential surface of the circumferential wall 93 of the casing 74. The positions of the three power modules 77 in the circumferential direction do not overlap with the positions of the plurality of second fastening pieces 97 (i.e., the fastening points of the casing 74 and the housing 36) in the circumferential direction, but overlap with the positions of the plurality of second cooling fins 96 in the circumferential direction. The three power modules 77 are arranged to avoid the uppermost portion of the casing 74. An arrow D1 appropriately shown in each drawing indicates a direction (hereinafter referred to as "the first direction D1") parallel to an inner surface 77A of each power module 77. An arrow D2 appropriately shown in each drawing indicates a direction (hereinafter referred to as "the second direction D2") perpendicular to the first direction D1 and the inner surface 77A of each power module 77.

Each power module 77 includes a flat module body 133, an AC module bus bar 134 extending from the front end (one end in the front-and-rear direction) of the module body 133 toward the inside in the radial direction, and a first DC module bus bar 135 and a second DC module bus bar 136 extending from the rear end (the other end in the front-and-rear direction) of the module body 133 toward the inside in the radial direction.

The three pressing members 78 are arranged at intervals in the circumferential direction. Each pressing member 78 includes a rectangular parallelepiped engagement piece 138 and a plurality of protruding pieces 139 protruding from the engagement piece 138 toward both sides in the circumferential direction. The engagement piece 138 engages with the engagement recess 107 of each pedestal 105 arranged on the inner circumferential surface of the circumferential wall 93 of the casing 74. The engagement piece 138 and the engagement recess 107 of each pedestal 105 sandwich the module body 133 of each power module 77. The engagement piece 138 presses the module body 133 of each power module 77 against the engagement recess 107 of each pedestal 105. An AC insert nut 142 is embedded in the front surface (the surface on one side in the front-and-rear direction) of the engagement piece 138. Two DC insert nuts 143 are embedded in the rear surface (the surface on the other side in the front-and-rear direction) of the engagement piece 138. Each protruding piece 139 is fixed to each fixing protrusion 106 of each pedestal 105 by a fixing bolt 144.

With reference to FIG. 9, the smoothing capacitor 79 is connected to the DC power supply 125 in parallel with the inverter 130. The smoothing capacitor 79 smooths the direct current input to the inverter 130 from the DC power supply 125. More specifically, the smoothing capacitor 79 protects the three power modules 77 by smoothing a pulse electric current (a pulse-shaped electric current caused by a surge voltage) generated in the direct current input from the DC power supply 125 to the three power modules 77.

With reference to FIG. 7, the smoothing capacitor 79 is arranged at an interval from the inner circumferential surface of the circumferential wall 93 of the casing 74. The smoothing capacitor 79 and the three power modules 77 are arranged in the left semicircular portion of the casing 74. The smoothing capacitor 79 is continuously arranged along the inner surfaces 77A of the three power modules 77 (more specifically, the inner surfaces in the radial direction of the module bodies 133 of the three power modules 77). Accordingly, as viewed from the front side (the side of the electric motor 31), the smoothing capacitor 79 and each power module 77 are arranged in order from the inside in the radial direction to the outside in the radial direction between the second through hole 113 of the bottom wall 94 of the casing 74 and the inner circumferential surface of the circumferential wall 93 of the casing 74.

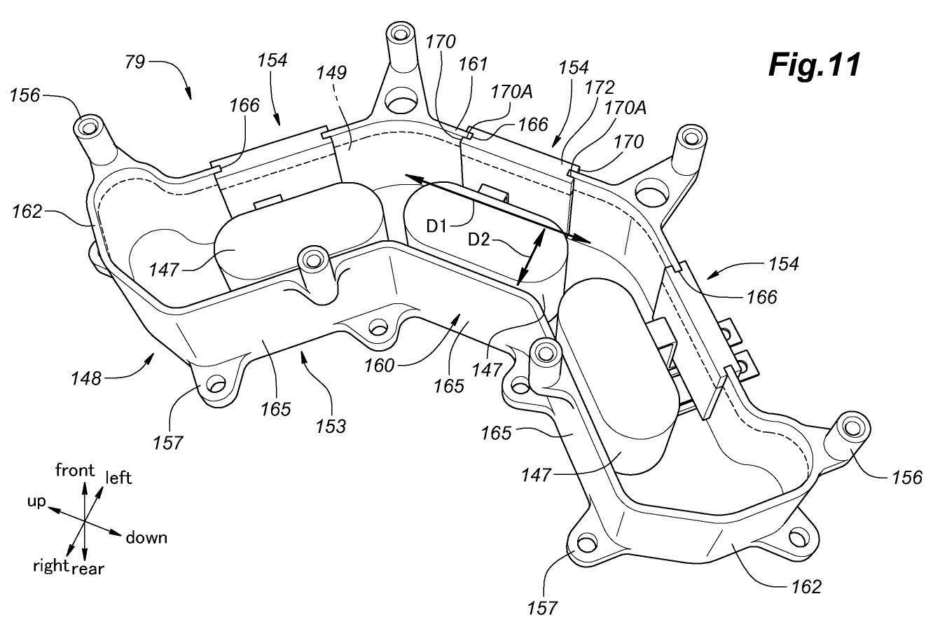

With reference to FIGS. 7, 10 and 11, the smoothing capacitor 79 includes a plurality of capacitor elements 147, a capacitor case 148 (an example of a case) that accommodates the plurality of capacitor elements 147, a mold material 149 (see FIG. 11) with which the inside of the capacitor case 148 is filled and that seals the plurality of capacitor elements 147, three first bus bars 150 connected to the plurality of capacitor elements 147, and three second bus bars 151 connected to the plurality of capacitor elements 147. That is, the smoothing capacitor 79 is a capacitor unit that gathers and integrates the plurality of capacitor elements 147.

The plurality of capacitor elements 147 is arranged adjacently to each other. Each capacitor element 147 has a cylindrical shape centered on an axis extending in the front-and-rear direction. That is, in the present embodiment, the axial direction of each capacitor element 147 is the front-and-rear direction.

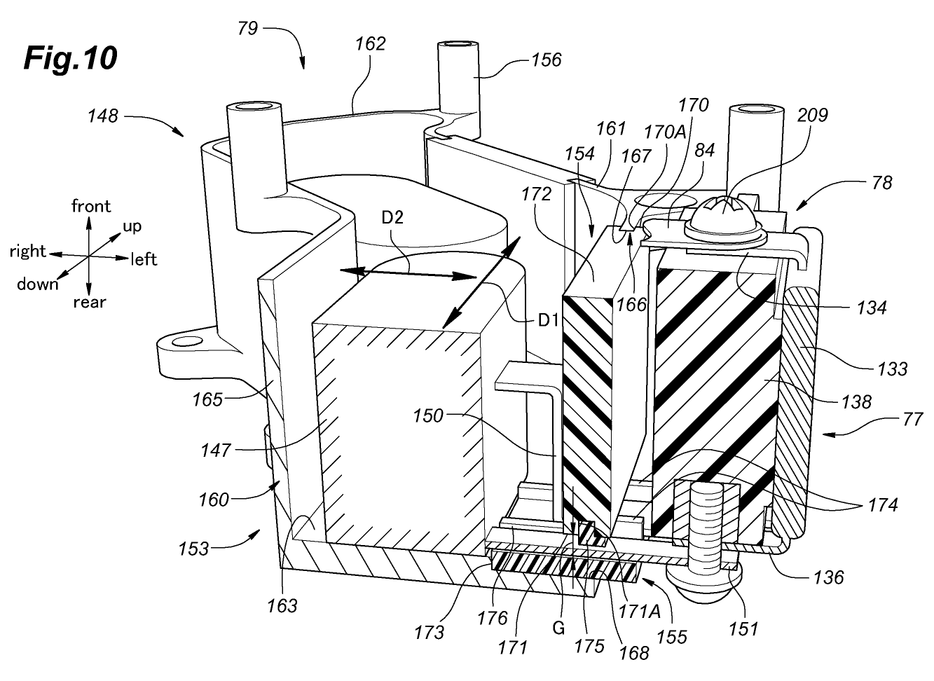

The capacitor case 148 includes a case body 153 that supports the plurality of capacitor elements 147, three wall bodies 154 formed separately from the case body 153 and attached to the case body 153, and three holding bodies 155 (only one of which is shown in FIG. 10) formed separately from the case body 153 and the three wall bodies 154 and holding the first and second bus bars 150, 151.

The case body 153 of the capacitor case 148 is made of a metal such as aluminum. A case opening is provided on the front surface (the surface on one side in the front-and-rear direction) of the case body 153. In other words, the case body 153 is a box-shaped member with the front surface opened. A plurality of support protrusions 156 is provided at the front end (one end in the front-and-rear direction) of the case body 153. A plurality of attachment protrusions 157 is provided at the rear end (the other end in the front-and-rear direction) of the case body 153. Each attachment protrusion 157 is attached to the bottom wall 94 of the casing 74 by an attachment bolt 158.

The case body 153 has a shape elongated in the circumferential direction. As viewed in the front-and-rear direction, the case body 153 is bent to protrude toward the outside in the radial direction (toward one side in the width direction of the case body 153), and is a substantially U-shaped member. The case body 153 includes an inner wall 160 extending in the circumferential direction, an outer wall 161 (an example of a wall on the one side in the width direction) extending in the circumferential direction on the outside in the radial direction of the inner wall 160, a pair of sidewalls 162 extending in the radial direction and connecting both ends of the inner wall 160 in the circumferential direction to both ends of the outer wall 161 in the circumferential direction, and a base wall 163 connecting the rear ends (the ends on the side opposite to the electric motor 31) of the inner wall 160, the outer wall 161, and the pair of sidewalls 162.

The inner wall 160 of the case body 153 rises vertically from the base wall 163. The inner wall 160 has three flat surfaces 165 formed on the inside in the radial direction of the plurality of capacitor elements 147. That is, the three flat surfaces 165 are provided at positions corresponding to the plurality of capacitor elements 147. As viewed from the front side (the side of the electric motor 31), each flat surface 165 extends along the first direction D1.

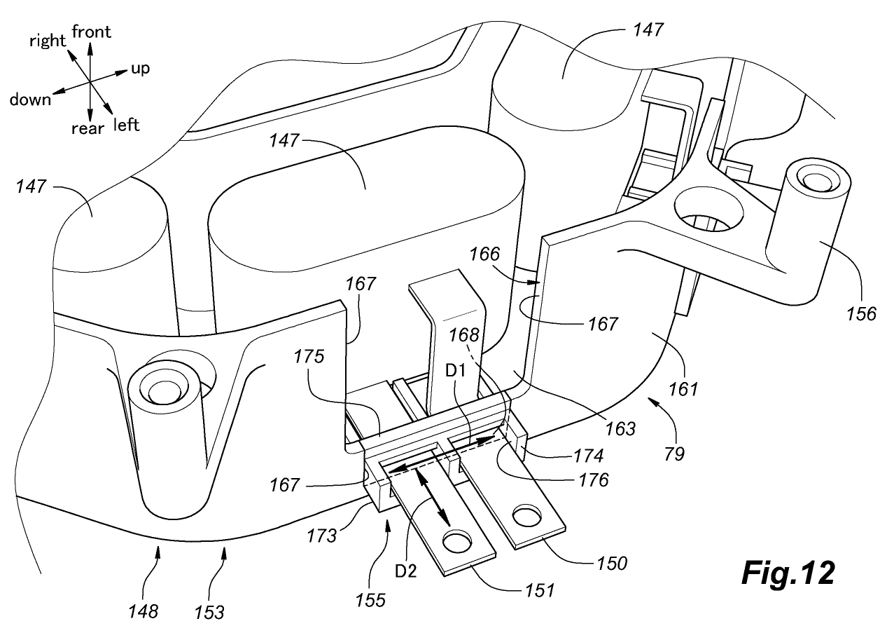

The outer wall 161 of the case body 153 rises vertically from the base wall 163. The outer wall 161 is provided with three notches 166 formed on the outside in the radial direction of the plurality of capacitor elements 147. That is, the three notches 166 are provided at positions corresponding to the plurality of capacitor elements 147. The three notches 166 are arranged at intervals in the circumferential direction (longitudinal direction of the case body 153). With reference to FIGS. 10 and 12, each notch 166 has a rectangular shape elongated in the front-and-rear direction and the first direction D1. Each notch 166 penetrates through the outer wall 161 in the radial direction (the width direction of the case body 153). Each notch 166 is continuously arranged from the front end (one end in the front-and-rear direction) of the outer wall 161 to the rear end (the other end in the front-and-rear direction) thereof. Each notch 166 includes a pair of side edges 167 extending in the front-and-rear direction, and a bottom edge 168 extending in the first direction D1 and connecting the rear ends of the pair of side edges 167. The pair of side edges 167 faces each other at a distance in the first direction D1.

With reference to FIG. 7, the base wall 163 of the case body 153 has a shape elongated in the circumferential direction. The plurality of capacitor elements 147 is placed on the front surface of the base wall 163. The rear surface of the base wall 163 contacts with the front surface (cooling surface) of the bottom wall 94 of the casing 74.

With reference to FIGS. 10 and 11, the three wall bodies 154 of the capacitor case 148 are attached to the outer wall 161 of the case body 153. The three wall bodies 154, together with the inner wall 160, the outer wall 161, and the pair of sidewalls 162 of the case body 153, define the outer shell (the portion that surrounds the plurality of capacitor elements 147 and the mold material 149) of the capacitor case 148. The three wall bodies 154 are arranged on the outside in the radial direction of the plurality of capacitor elements 147. That is, the three wall bodies 154 are provided at positions corresponding to the plurality of capacitor elements 147.

Each wall body 154 has a flat rectangular shape elongated in the front-and-rear direction and the first direction D1. That is, each wall body 154 has a shape corresponding to each notch 166 of the case body 153. Each wall body 154 engages with the corresponding notch 166 of the case body 153. Each wall body 154 is made of an insulating resin.

Each wall body 154 includes a pair of side portions 170 extending in the front-and-rear direction, a bottom portion 171 extending in the first direction D1 and connecting the rear ends of the pair of side portions 170, and a top portion 172 extending in the first direction D1 and connecting the front ends of the pair of side portions 170. A first engagement groove 170A is formed on each side portion 170 along the front-and-rear direction. The first engagement groove 170A engages with each side edge 167 of each notch 166 of the case body 153. A second engagement groove 171A is formed on the bottom portion 171 along the first direction D1. A gap G is provided between the bottom portion 171 and the bottom edge 168 of each notch 166 of the case body 153. The top portion 172 is provided flush with the front surface (the surface on one side in the front-and-rear direction) of the outer wall 161 of the case body 153.

With reference to FIGS. 10 and 12, the three holding bodies 155 (only one of which is shown in FIGS. 10 and 12) of the capacitor case 148 are attached to the outer wall 161 and the base wall 163 of the case body 153. Each holding body 155 engages with the corresponding notch 166 of the case body 153 at the rear side of the corresponding wall body 154. Each holding body 155 fills the entire gap G and surrounds the portions of the first and second bus bars 150, 151 that penetrate through the gap G. In another embodiment, each holding body 155 may fill a portion of the gap G. Each holding body 155 is formed of an insulating resin.

Each holding body 155 includes a flat base plate 173, the plurality of first ribs 174 protruding from the front surface (one surface) of the base plate 173, and a second rib 175 facing the front surface of the base plate 173 at an interval. The base plate 173 has a shape elongated in the first direction D1 and the second direction D2. The plurality of first ribs 174 is arranged at intervals in the first direction D1 and extends in the second direction D2. A plurality of holding grooves 176 is formed between the plurality of first ribs 174 on the front surface of the base plate 173. The second rib 175 extends in the first direction D1 and connects the central portions of the plurality of first ribs 174 in the second direction D2. The second rib 175 engages with the second engagement groove 171A of the bottom portion 171 of each wall body 154.

With reference to FIG. 11, the mold material 149 is made of, for example, an insulating resin. The mold material 149 entirely covers the capacitor elements 147.

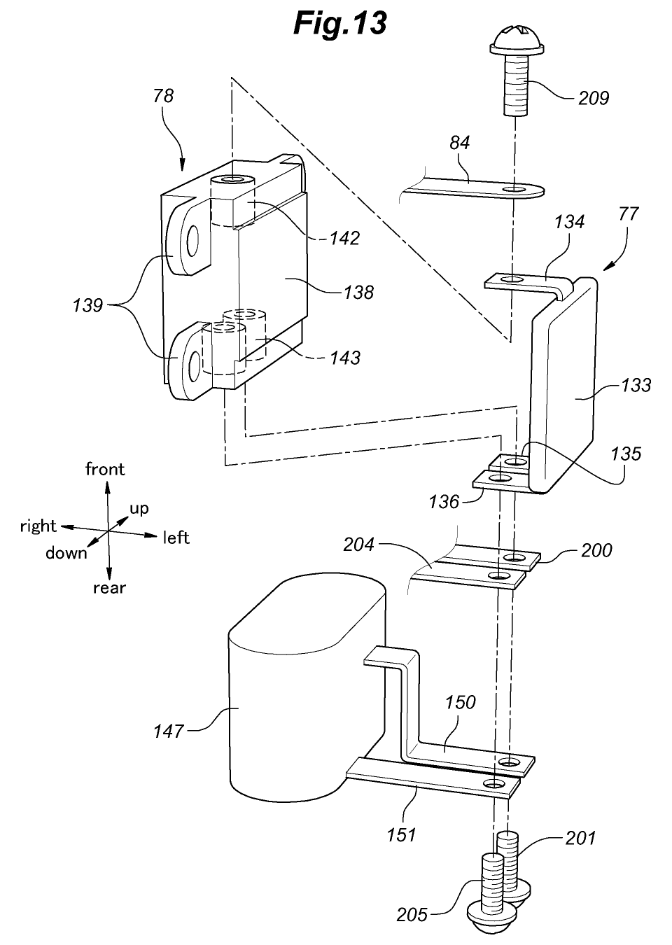

With reference to FIGS. 12 and 13, the three first bus bars 150 and the three second bus bars 151 (only one of each is shown in FIGS. 12 and 13) are provided at positions corresponding to the plurality of capacitor elements 147. One of the three first bus bars 150 and one of the three second bus bars 151 gather at a position corresponding to each notch 166 of the case body 153.

With reference to FIGS. 10 and 13, each first bus bar 150 connects each capacitor element 147 to each power module 77. The end on the inside in the radial direction of each first bus bar 150 is connected to the upper portion of the side surface (the surface on the outside in the radial direction) of each capacitor element 147. Each first bus bar 150 is held by each holding groove 176 of each holding body 155 of the capacitor case 148. Each first bus bar 150 penetrates through the gap G (see FIG. 10) and extends to the rear side of each pressing member 78. The portion of each first bus bar 150 that penetrates through the gap G is surrounded by the base plate 173, the plurality of first ribs 174, and the second rib 175 of each holding body 155.

With reference to FIGS. 10 and 13, each second bus bar 151 connects each capacitor element 147 to each power module 77. The end on the inside in the radial direction of each second bus bar 151 is connected to the lower portion of the side surface (the surface on the outside in the radial direction) of each capacitor element 147. Each second bus bar 151 is held by each holding groove 176 of each holding body 155 of the capacitor case 148. Each second bus bar 151 penetrates through the gap G (see FIG. 10) and extends to the rear side of each pressing member 78. The portion of each second bus bar 151 that penetrates through the gap G is surrounded by the base plate 173, the plurality of first ribs 174, and the second rib 175 of each holding body 155.

With reference to FIG. 6, the first DC bus bar 82 includes a first main bus bar 199 extending in the circumferential direction, and three first auxiliary bus bars 200 bent from the outer circumferential portion of the first main bus bar 199 toward the rear side. One end of the first main bus bar 199 in the circumferential direction is connected to one DC input terminal 126 of the DC input connector 76. With reference to FIG. 13, the tip end of each first auxiliary bus bar 200 is bent toward the outside in the radial direction and extends to the rear side of each pressing member 78. The tip end of each first auxiliary bus bar 200, the first DC module bus bar 135 of each power module 77, and the end on the outside in the radial direction of each first bus bar 150 are fixed to one DC insert nut 143 of each pressing member 78 by a first fixing bolt 201. Accordingly, the first DC bus bar 82, each power module 77, and each first bus bar 150 are connected to each other.

With reference to FIG. 6, the second DC bus bar 83 includes a second main bus bar 203 extending in the circumferential direction, and three second auxiliary bus bars 204 bent from the outer circumferential portion of the second main bus bar 203 toward the rear side. One end of the second main bus bar 203 in the circumferential direction is connected to the other DC input terminal 126 of the DC input connector 76. With reference to FIG. 13, the tip end of each second auxiliary bus bar 204 is bent toward the outside in the radial direction and extends to the rear side of each pressing member 78. The tip end of each second auxiliary bus bar 204, the second DC module bus bar 136 of each power module 77, and the end on the outside in the radial direction of each second bus bar 151 are fixed to the other DC insert nut 143 of each pressing member 78 by a second fixing bolt 205. Accordingly, the second DC bus bar 83, each power module 77, and each second bus bar 151 are connected to each other.

With reference to FIGS. 6 and 13, one end in the longitudinal direction of each AC bus bar 84 and the AC module bus bar 134 of each power module 77 are fixed to the AC insert nut 142 of each pressing member 78 by a third fixing bolt 209. Accordingly, each AC bus bar 84 and each power module 77 are electrically connected to each other.

The communication connector 86 fits into the second fitting hole 117 of the bottom wall 94 of the casing 74 and passes through the bottom wall 94 of the casing 74. The communication connector 86 is connected to an external device (for example, the controller provided on the body 2) provided outside the propulsion drive device 16.

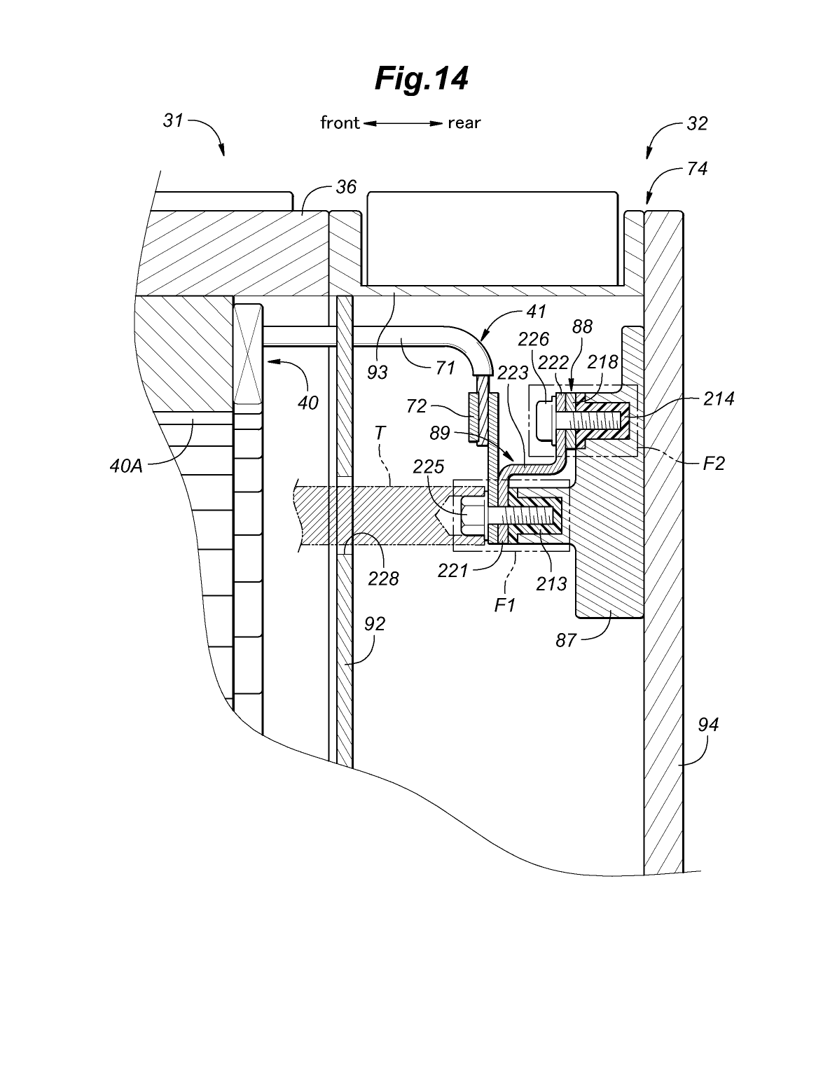

With reference to FIGS. 6 and 14, the support member 87 is fixed to the front surface of the bottom wall 94 of the casing 74. The support member 87 is an integrally molded product made of metal or resin. The support member 87 is formed separately from the resolver 75. Three first fastening members 213 and three second fastening members 214 (only one of each is shown in FIG. 14) are embedded in the front surface of the support member 87. Each second fastening members 214 is arranged on the rear side (the side opposite to the electric motor 31) and on the outside in the radial direction of each first fastening members 213.

With reference to FIG. 6, the three electric current sensors 88 are concentrated in the right semicircular portion (an example of one semicircular portion) of the casing 74. The three electric current sensors 88 are arranged at intervals in the circumferential direction. The three electric current sensors 88 are supported by the outer circumferential portion of the support member 87. Each electric current sensor 88 is electrically connected to each power module 77 via each AC bus bar 84, and detects an electric current value output from each power module 77.

Each electric current sensor 88 includes a sensor main body 216, a first sensor bus bar 217 extending upward from the sensor main body 216, and a second sensor bus bar 218 extending downward from the sensor main body 216. The first sensor bus bar 217 and the other end in the longitudinal direction of each AC bus bar 84 are fixed to the front surface of the support member 87 via a fourth fastening bolt 219. Accordingly, each electric current sensor 88 and each AC bus bar 84 are electrically connected to each other.

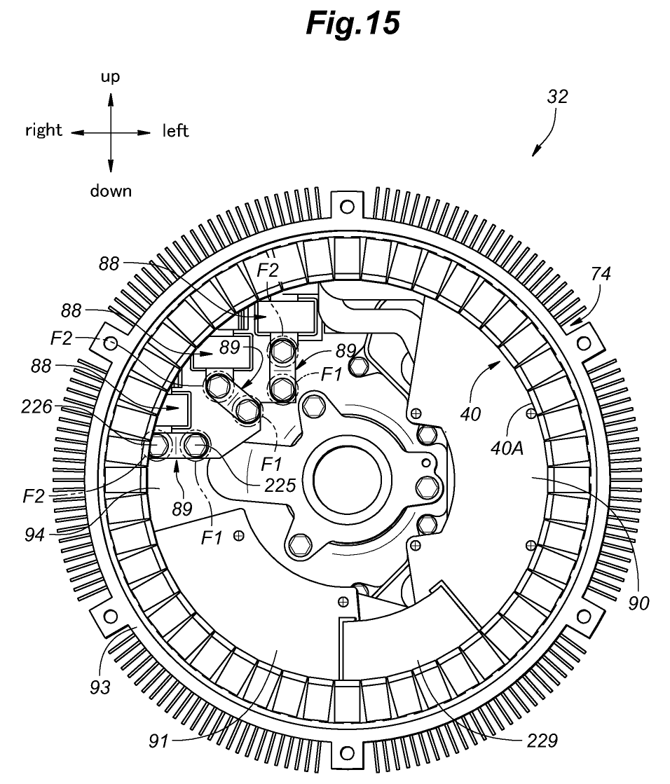

With reference to FIGS. 14 and 15, the three intermediate bus bars 89 are arranged along the front surface of the support member 87. Each intermediate bus bar 89 includes a first intermediate piece 221, a second intermediate piece 222 arranged on the rear side (the side opposite to the electric motor 31) and on the outside in the radial direction of the first intermediate piece 221, and connecting piece 223 extending in the front-and-rear direction and connecting the first intermediate piece 221 and the second intermediate piece 222.

The first intermediate piece 221 of each intermediate bus bar 89 and the motor bus bar 72 of each electrically connected member 41 are fastened to each first fastening member 213 via a first bolt 225 (an example of a first fastener). Accordingly, each electrically connected member 41 is fastened to each intermediate bus bar 89 via the first bolt 225, and each electrically connected member 41 and each intermediate bus bar 89 are electrically connected to each other. The first bolt 225 is arranged along the front-and-rear direction and fastens each electrically connected member 41 to each intermediate bus bar 89 along the front-and-rear direction.

Hereinafter, the fasting portion between each electrically connected member 41 and each intermediate bus bar 89 will be referred to as "the first fasting portion F1." In the present embodiment, the propulsion drive device 16 is provided with the three first fastening portions F1. The three first fastening portions F1 are arranged adjacently to the three electric current sensors 88. When the propulsion drive device 16 is viewed in the front-and-rear direction, all the three first fastening portions F1 are arranged inside the casing 74 and do not overlap with the stator 40. More specifically, when the propulsion drive device 16 is viewed in the front-and-rear direction, all the three first fastening portions F1 are arranged on the inner side of the inner circumferential surface 40A of the stator 40 and are concentrated in the right semicircular portion of the controller 32. When the propulsion drive device 16 is viewed in the front-and-rear direction, the three first fastening portions F1 are arranged so as not to overlap with the drive board 90 and the control board 91.

The second intermediate piece 222 of each intermediate bus bar 89 and the second sensor bus bar 218 of each electric current sensor 88 are fastened to each second fastening member 214 via a second bolt 226 (an example of a second fastener). Accordingly, each electric current sensor 88 is fastened to each intermediate bus bar 89 via the second bolt 226, and each electric current sensor 88 and each intermediate bus bar 89 are electrically connected to each other. The second bolt 226 is arranged along the front-and-rear direction and fastens each electric current sensor 88 to each intermediate bus bar 89 along the front-and-rear direction.

Hereinafter, the fastening portion between each electric current sensor 88 and each intermediate bus bar 89 will be referred to as "the second fastening portion F2." In the present embodiment, the propulsion drive device 16 is provided with the three second fastening portions F2. The three second fastening portions F2 are arranged adjacently to the three electric current sensors 88. When the propulsion drive device 16 is viewed along the front-and-rear direction, two of the three second fastening portions F2 are arranged inside the casing 74 and do not overlap with the stator 40. When the propulsion drive device 16 is viewed along the front-and-rear direction, one of the three second fastening portions F2 is arranged so as to partially overlap with the stator 40. In another embodiment, when the propulsion drive device 16 is viewed along the front-and-rear direction, all the three second fastening portions F2 may be arranged inside the casing 74 so as not to overlap with the stator 40, or all the three second fastening portions F2 may overlap with the stator 40. Each second fastening portion F2 is arranged on the rear side (the side opposite to the electric motor 31) and on the outside in the radial direction of each first fastening portion F1. In other words, each second fastening portion F2 is provided at a position different from each first fastening portion F1.

With reference to FIGS. 6 and 15, the drive board 90 is a gate drive board for driving each switching element 128 (see FIG. 9) of the three power modules 77. The drive board 90 is electrically connected to the three power modules 77. The drive board 90 is arranged on the front side (the side of the electric motor 31) of the smoothing capacitor 79. The drive board 90 is supported by the plurality of support protrusions 156 provided in the case body 153 of the capacitor case 148 of the smoothing capacitor 79. When the propulsion drive device 16 is viewed in the front-and-rear direction, the drive board 90 is arranged so as not to overlap with the three first fastening portions F1 and the three second fastening portions F2.

The control board 91 is an ECU board that controls driving of the inverter 130 (three power modules 77) via the drive board 90. The control board 91 is electrically connected to the three power modules 77 via the drive board 90. The control board 91 is connected to the drive board 90 via a board connector 229, and is also connected to the communication connector 86 via a cable (not shown). The control board 91 is held by a holding member (not shown) attached to the bottom wall 94 of the casing 74. When the propulsion drive device 16 is viewed in the front-and-rear direction, the control board 91 is arranged so as not to overlap with the three first fastening portions F1 and the three second fastening portions F2.

With reference to FIGS. 5 and 14, the separating member 92 separates the internal space of the housing 36 from the internal space of the casing 74. The separating member 92 separates the rotor 39 and the stator 40 of the electric motor 31 from the structural components E (for example, the three power modules 77, the smoothing capacitor 79, the three electric current sensors 88, the drive board 90, and the control board 91) of the controller 32. The separating member 92 is accommodated in the casing 74. In another embodiment, the separating member 92 may be accommodated in the housing 36.

An axial hole 227 is formed in the central portion of the separating member 92. The extending portion 56 of the shaft 38 penetrates through the axial hole 227. A through hole 228 is formed on the outer circumferential portion of the separating member 92 along the front-and-rear direction. When the propulsion drive device 16 is viewed in the front-and-rear direction, the through hole 228 is arranged so as to overlap with the three first fastening portions F1.

### the fan 33

With reference to FIGS. 3 to 5, the fan 33 is arranged on the front side (one side in the front-and-rear direction) of the electric motor 31. The fan 33 is arranged on the side opposite to the controller 32 with the electric motor 31 interposed therebetween. The fan 33 includes a cylindrical hub 233 extending in the front-and-rear direction, a cylindrical rim 234 extending in the front-and-rear direction on the outer circumference of the hub 233, and a plurality of spokes 235 extending in the radial direction and connecting the hub 233 and the rim 234. The hub 233 is fixed to the protruding portion 57 of the shaft 38 of the electric motor 31. Accordingly, the fan 33 is configured to rotate integrally with the shaft 38. A plurality of air blowing ribs 236 is provided on the outer circumferential surface of the rim 234 at intervals in the circumferential direction of the rim 234. Each air blowing rib 236 inclines forward (to one side in the front-and-rear direction) toward the downstream side in the rotational direction R of the fan 33.

### The Duct Cover 34

With reference to FIGS. 3 and 5, the duct cover 34 has a cylindrical shape extending in the front-and-rear direction. A cooling air passage 239 is formed between the duct cover 34 and both the housing 36 of the electric motor 31 and the circumferential wall 93 of the casing 74 of the controller 32. That is, the cooling air passage 239 is formed on the outer circumference of the housing 36 of the electric motor 31 and the casing 74 of the controller 32. The cooling air passage 239 is cylindrical and extends in the front-and-rear direction.

### assembly process of the propulsion drive device 16

Next, the assembly process of the propulsion drive device 16 configured as described above will be described. In assembling the propulsion drive device 16, an operator sequentially performs an initial process, an attaching process, a fastening process, an arranging process, and a final process. In another embodiment, an assembly apparatus including a computer may perform some or all of the above-described processes instead of the operator.

With reference to FIGS. 6 and 14, in the initial process, the operator fastens each electric current sensor 88 supported by the outer circumference portion of the support member 87 to each intermediate bus bar 89. More specifically, the operator arranges the second bolt 226 along the front-and-rear direction, and fastens the second sensor bus bar 218 of each electric current sensor 88 to the second intermediate piece 222 of each intermediate bus bars 89 along the front-and-rear direction using the second bolt 226. Further, the operator accommodates the separating member 92 in the casing 74 of the controller 32.

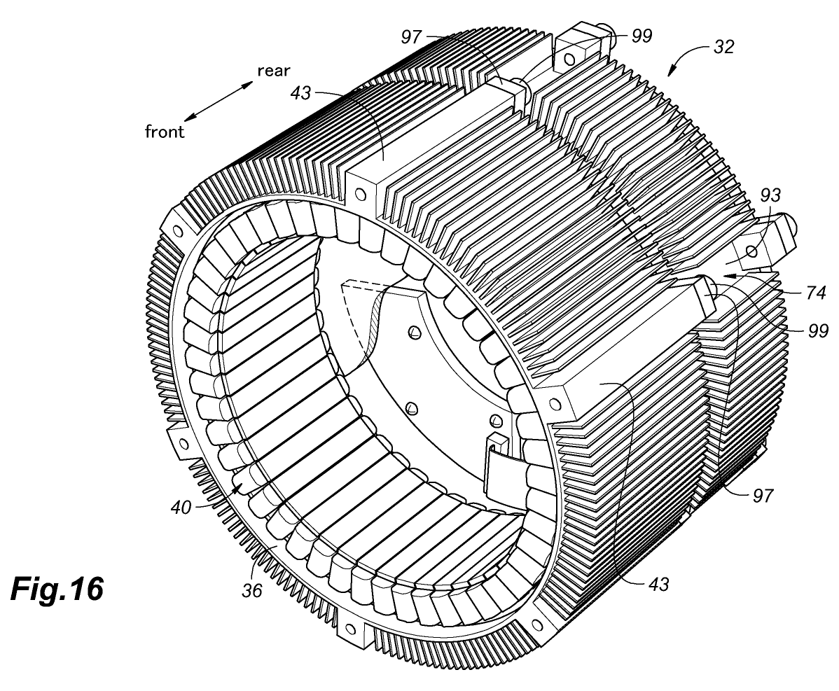

With reference to FIG. 16, in the attaching process, the operator attaches the housing 36 and the stator 40 of the electric motor 31 to the casing 74 of the controller 32. More specifically, with the stator 40 fixed to the housing 36, the operator fastens each second fastening piece 97 of the casing 74 to each fastening protrusion 43 of the housing 36 using the second fastening bolt 99.

With reference to FIG. 14, in the fastening process, when the propulsion drive device 16 is viewed in the front-and-rear direction, the operator fastens each electrically connected member 41 to each intermediate bus bar 89 on the inner side of the inner circumferential surface 40A of the stator 40. More specifically, the operator arranges the first bolt 225 along the front-and-rear direction, and tightens the first bolt 225 using a tool T which has passed through the inner diameter side (inner circumferential side) of the stator 40, thereby fastening the motor bus bar 72 of each electrically connected member 41 to the first intermediate piece 221 of each intermediate bus bar 89 along the front-and-rear direction by the first bolt 225.

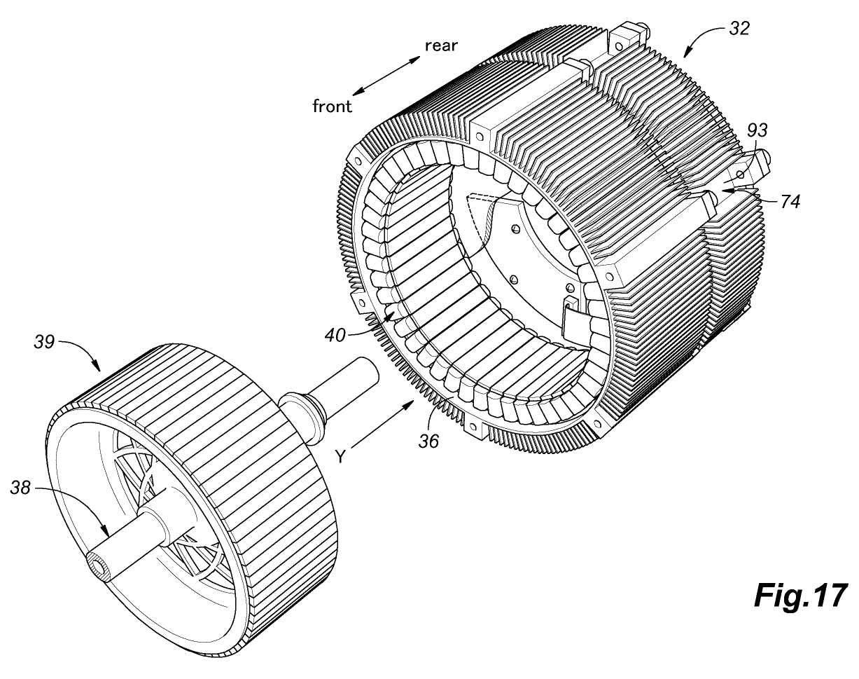

With reference to FIG. 17, in the arranging process, the operator arranges the rotor 39 to face the stator 40 in the radial direction. More specifically, the operator inserts the rotor 39 into the space on the inner circumference side of the stator 40 as indicated by an arrow Y in FIG. 17.

With reference to FIG. 5, in the final process, the operator attaches the lid 37 of the electric motor 31 to the housing 36 of the electric motor 31. More specifically, the operator fastens the fastening protrusion 43 of the housing 36 to the first fastening piece 47 of the lid 37 using the first fastening bolt 49. Further, the operator fixes the fan 33 to the shaft 38 of the electric motor 31, and mounts the duct cover 34 on the outer circumference of the electric motor 31, the controller 32, and the fan 33.

### Effects

In the above embodiment, when the propulsion drive device 16 is viewed in the front-and-rear direction, all the three first fastening portions F1 are arranged inside the casing 74 and do not overlap with the stator 40. Accordingly, a space can be easily secured through which the tool T for fastening each electrically connected member 41 to each intermediate bus bar 89 can be passed. Accordingly, the workability of assembling the propulsion drive device 16 is improved. Further, since the electrical connections in the three first fastening portions F1 can be visually confirmed, the reliability of the electrical connections in the three first fastening portions F1 is improved.

Further, in a case where the first fastening portion F1 is arranged on the outer circumference of the housing 36 or the casing 74, the first and second cooling fins 42, 96 cannot be arranged around the first fastening portion F1. Accordingly, the numbers of the first and second cooling fins 42, 96 are reduced, and the cooling performance for the electric motor 31 and the controller 32 may be reduced. In contrast, in the above embodiment, since the first fastening portion F1 is arranged inside the casing 74, there is no need to reduce the numbers of the first and second cooling fins 42, 96. Accordingly, a reduction in the cooling performance for the electric motor 31 and the controller 32 can be suppressed. The same effect is exhibited by the second fastening portion F2.

Further, in a case where the first fastening portion F1 is exposed to the outside of the propulsion drive device 16, a cover that covers the first fastening portion F1 is required to protect the first fastening portion F1. If a cover is added in this way, there is a possibility that the number of components of the propulsion drive device 16 will increase, the weight of the propulsion drive device 16 will increase, or the size of the propulsion drive device 16 will increase. In contrast, in the above embodiment, since the first fastening portion F1 is arranged inside the casing 74, a cover for covering the first fastening portion F1 is not required. Accordingly, the number of components of the propulsion drive device 16 can be reduced, and the propulsion drive device 16 can be made lighter and smaller. The same effect is exhibited by the second fastening portion F2.

Further, in a case where the fastening directions of the first bolt 225 and the second bolt 226 are opposite to each other, the heads of the first bolt 225 and the second bolt 226 will be arranged to face each other, and the workability in assembling the propulsion drive device 16 may be reduced. In contrast, in the above embodiment, the fastening direction of the first bolt 225 (direction from the front to the rear) and the fastening direction of the second bolt 226 (direction from the front to the rear) are the same. Accordingly, the workability in assembling the propulsion drive device 16 is further improved.

### Other modifications

In the above embodiment, the intermediate bus bar 89 is fastened to the electric current sensor 88 via the second bolt 226. In another embodiment, the intermediate bus bar 89 may be fastened to the AC bus bar 84 or the power module 77 via the second bolt 226. That is, in the above embodiment, the electric current sensors 88 are used as the conductive members, but according to another embodiment, the AC bus bars 84 or the power modules 77 may be used as the conductive members.

In the above embodiment, the intermediate bus bars 89 are used as the intermediate members. In another embodiment, components other than the bus bar (for example, the cable) may be used as the intermediate members.

In the above embodiment, the electrically connected member 41 is electrically connected to the electric current sensor 88 via the intermediate bus bar 89. In another embodiment, the electrically connected member 41 may be directly fastened to the electric current sensor 88 or the AC bus bar 84 without interposing the intermediate bus bars 89. That is, according to another embodiment, the intermediate bus bars 89 may be omitted.

In the above embodiment, the electrically connected member 41 consists of the cable 71 and the motor bus bar 72. In another embodiment, the entire electrically connected member 41 may be constituted by either the cable 71 or the motor bus bar 72, or the electrically connected member 41 may be constituted by members other than the cable 71 and the motor bus bar 72.

In the above embodiment, both the first and second fastening portionsF1, F2 are arranged inside the casing 74 of the controller 32. In another embodiment, at least one of the first and second fastening portions F1, F2 may be arranged inside the housing 36 of the electric motor 31.

In the above embodiment, an inner rotor radial gap type electric motor 31 is used. In another embodiment, an outer rotor type electric motor or an axial gap type electric motor may be used.

In the above embodiment, the configuration of the present invention is applied to the propulsion drive device 16. In another embodiment, the configuration of the present invention may be applied to the lift drive device 12.

In the above embodiment, the configuration of the present invention is applied to an electric vertical take-off and landing aircraft. In another embodiment, the configuration of the present invention may be applied to an aircraft other than an electric vertical take-off and landing aircraft (i.e., a general aircraft that cannot take off and land vertically), or the configuration of the present invention may be applied to a mobile body other than an aircraft (for example, a vehicle such as an automobile or a motorcycle). Further, in another embodiment, the configuration of the present invention may be applied to a device that is fixedly installed.

This concludes the description of the specific embodiments, but the present invention is not limited to the above embodiments or modifications, and can be widely modified and implemented.

### Summary of embodiment

Hereinafter, the phrase "along the axial direction" not only means "in a direction parallel to the axial direction" but also means "in a direction slightly inclined relative to the axial direction.

The electric drive device 16 includes the electric motor 31 and the controller 32 that controls the electric motor 31. The electric motor 31 includes the stator 40 and the at least one electrically connected member 41 electrically connected to the stator 40. The electrically connected member 41 is fastened to the controller 32. When the electric drive device 16 is viewed in the axial direction of the electric motor 31, the fastening portion F1 between the electrically connected member 41 and the controller 32 is arranged inside the electric drive device 16 and does not overlap with the stator 40.

According to this aspect, a space can be easily secured through which the tool T for fastening the electrically connected member 41 to the controller 32 can be passed. Accordingly, the workability of assembling the electric drive device 16 is improved.

The controller 32 includes the conductive members 88, and the intermediate members 89 that is fastened to the electrically connected member 41 via the first fastener 225 at the fastening portion F1, and fastened to the conductive members 88 via the second fastener 226 at the second fastening portion F2 provided at a position different from the fastening portion F1. The first fastener 225 is arranged along the axial direction of the electric motor 31 and fastens the electrically connected members 41 to the intermediate members 89 along the axial direction of the electric motor 31, and the second fastener 226 is arranged along the axial direction of the electric motor 31 and fastens the conductive members 88 to the intermediate members 89 along the axial direction of the electric motor 31.

According to this aspect, by aligning the arrangement directions and fastening directions of the first and second fasteners 225, 226, the workability in assembling the electric drive device 16 is further improved. Further, by fastening the electrically connected member 41 and the conductive members 88 to the intermediate members 89 via the first and second fasteners 225, 226, inspection of the electrical connections of these members becomes easier compared to the case where these members are fixed by crimping or welding. Further, by fastening the electrically connected member 41 and the conductive members 88 to the intermediate members 89 via the first and second fasteners 225, 226, the reliability of the electrical connection between these members is improved compared to the case where these members are fixed by an insert structure.

When the electric drive device 16 is viewed in the axial direction of the electric motor 31, the fastening portion F1 between the electrically connected member 41 and the controller 32 is arranged on the inner side of the inner circumferential surface 40A of the stator 40.

According to this aspect, the electric drive device 16 can be made smaller compared to the case where the fastening portion F1 is arranged on the outer circumferential side of the stator 40. Further, since the fastening portion F1 can be easily viewed, the workability of assembling and inspecting the electric drive device 16 is improved.

The controller 32 includes the electronic component 77 and the circuit boards 90 and 91 electrically connected to the electronic component 77. When the electric drive device 16 is viewed in the axial direction of the electric motor 31, the circuit boards 90 and 91 are arranged so as not to overlap with the fastening portion F1 between the electrically connected member 41 and the controller 32.

According to this aspect, without removing the circuit boards 90 and 91, the space can be secured through which the tool T for fastening the electrically connected member 41 to the controller 32 can be passed. Accordingly, the workability in assembling the electric drive device 16 is further improved.

The at least one electrically connected member comprises a plurality of electrically connected members, and when the electric drive device 16 is viewed in the axial direction of the electric motor 31, all the fastening portions F1 between the electrically connected members 41 and the controller 32 are arranged on the inner side of the inner circumferential surface 40A of the stator 40, and are concentrated in one semicircular portion of the controller 32.

According to this aspect, by concentrating the arrangement of a plurality of fastening portions F1 in one semicircular portion of the controller 32, a large space for arranging the circuit boards 90 and 91 can be secured in the other semicircular portion of the controller 32. This improves the degree of freedom in the shape and layout of the circuit boards 90 and 91. Further, the members supporting the plurality of fastening portions F1 can be integrated to reduce the weight.

The controller 32 includes the electronic component 77 and an electric current sensor 88 that detects the electric current value output from the electronic component 77, and the fastening portion F1 between the electrically connected member 41 and the controller 32 is arranged adjacently to the electric current sensor 88.

According to this aspect, by shortening the length of the connection portion between the electric current sensor 88 and the fastening portion F1, the electric resistance of the connection portion can be reduced. Further, by concentrating the arrangement of the electric current sensors 88 and the fastening portion F1 in a small space, a large space can be secured for arranging other components. This improves the degree of freedom in layout of other components.

The electric drive device 16 further includes a separating member 92 that separates the internal space of the electric motor 31 from the internal space of the controller 32, and a through hole 228 is arranged in the separating member 92 along the axial direction of the electric motor 31. When the electric drive device 16 is viewed in the axial direction of the electric motor 31, the through hole 228 is arranged so as to overlap with the fastening portion F1 between the electrically connected member 41 and the controller 32.

According to this aspect, without removing the separating member 92, the space can be secured through which the tool T for fastening the electrically connected member 41 to the controller 32 can be passed. Accordingly, the workability of assembling the electric drive device 16 is improved.

The assembling method of the electric drive device 16, the electric drive device 16 including the electric motor 31 including the stator 40, the rotor 39 rotatable relative to the stator 40, and the electrically connected member 41 electrically connected to the stator 40, and the controller 32 that controls the electric motor 31. The assembling method includes the sequential processes of attaching the stator 40 to the controller 32, fastening the electrically connected member 41 to the controller 32, and arranging the rotor 39 to face the stator 40. In the fastening process, when the electric drive device 16 is viewed in the axial direction of the electric motor 31, the electrically connected member 41 is fastened to the controller 32 on the inner side of the inner circumferential surface 40A of the stator 40.

According to this aspect, the space can be easily secured through which the tool T for fastening the electrically connected member 41 to the controller 32 can be passed. Accordingly, the workability of assembling the electric drive device 16 is improved. Further, the electric drive device 16 can be made smaller compared to the case where the electrically connected member 41 is fastened to the controller 32 on the outer circumference side of the stator 40.

The controller 32 includes the conductive member 88, and the intermediate member 89 fastened to the electrically connected members 41 and the conductive member 88. In the fastening process, the first fastener 225 is arranged along the axial direction of the electric motor 31, and the electrically connected members 41 are fastened to the intermediate members 89 along the axial direction of the electric motor 31 by the first fastener 225. Prior to the attaching process, the second fastener 226 is arranged along the axial direction of the electric motor 31, and the conductive member 88 is fastened to the intermediate members 89 along the axial direction of the electric motor 31 by the second fastener 226.

According to this aspect, by aligning the arrangement directions and fastening directions of the first and second fasteners 225, 226, the workability in assembling the electric drive device 16 is further improved. Further, by fastening the electrically connected member 41 and the conductive members 88 to the intermediate members 89 via the first and second fasteners 225, 226, inspection of the electrical connections of these members becomes easier compared to the case where these members are fixed by crimping or welding. Further, by fastening the electrically connected member 41 and the conductive members 88 to the intermediate members 89 via the first and second fasteners 225, 226, the reliability of the electrical connection between these members is improved compared to the case where these members are fixed by an insert structure.

The wiring structure of the electric device 16, the wiring structure including the tubular member 40 extending in the axial direction, the electrically connected member 41 electrically connected to the tubular member 40, and the members to be fastened 89 fastened to the electrically connected member 41, and when the electric device 16 is viewed in the axial direction, the fastening portion F1 between the electrically connected member 41 and the members to be fastened 89 is arranged inside the electric device 16 and does not overlap with the tubular member 40.

According to this aspect, a space can be easily secured through which the tool T for fastening the electrically connected member 41 to the members to be fastened 89 can be passed. Accordingly, the workability of assembling the electric device 16 is improved.

1. An electric drive device comprising:
an electric motor; and
a controller configured to control the electric motor,
wherein the electric motor includes:
a stator; and
at least one electrically connected member electrically connected to the stator,
the electrically connected member is fastened to the controller, and
when the electric drive device is viewed in an axial direction of the electric motor, a fastening portion between the electrically connected member and the controller is arranged inside the electric drive device and does not overlap with the stator.

2. The electric drive device according to claim 1, wherein the controller includes:
a conductive member; and
an intermediate member that is fastened to the electrically connected member via a first fastener at the fastening portion, and fastened to the conductive member via a second fastener at a second fastening portion provided at a position different from the fastening portion,
wherein the first fastener is arranged along the axial direction of the electric motor and fastens the electrically connected member to the intermediate member along the axial direction of the electric motor, and
the second fastener is arranged along the axial direction of the electric motor and fastens the conductive member to the intermediate member along the axial direction of the electric motor.

3. The electric drive device according to claim 1, wherein, when the electric drive device is viewed in the axial direction of the electric motor, the fastening portion between the electrically connected member and the controller is arranged on an inner side of an inner circumferential surface of the stator.

4. The electric drive device according to claim 3, wherein the controller includes:
an electronic component; and
a circuit board electrically connected to the electronic component, and
when the electric drive device is viewed in the axial direction of the electric motor, the circuit board is arranged so as not to overlap with the fastening portion between the electrically connected member and the controller.

5. The electric drive device according to claim 4, wherein the at least one electrically connected member comprises a plurality of electrically connected members, and
when the electric drive device is viewed in the axial direction of the electric motor, all the fastening portions between the plurality of electrically connected members and the controller are arranged on the inner side of the inner circumferential surface of the stator and are concentrated in one semicircular portion of the controller.

6. The electric drive device according to claim 3, wherein the controller includes:
an electronic component; and
an electric current sensor configured to detect an electric current value output from the electronic component, and
the fastening portion between the electrically connected member and the controller is arranged adjacently to the electric current sensor.

7. The electric drive device according to claim 1, further comprising a separating member that separates an internal space of the electric motor from an internal space of the controller,
wherein a through hole is arranged in the separating member along the axial direction of the electric motor, and
when the electric drive device is viewed in the axial direction of the electric motor, the through hole is arranged so as to overlap with the fastening portion between the electrically connected member and the controller.

8. An assembling method of an electric drive device,
the electric drive device comprising:
an electric motor including a stator, a rotor rotatable relative to the stator, and an electrically connected member electrically connected to the stator; and
a controller configured to control the electric motor,
the assembling method comprising the sequential processes of:
attaching the stator to the controller;
fastening the electrically connected member to the controller; and
arranging the rotor to face the stator,
wherein, in the fastening process, when the electric drive device is viewed in an axial direction of the electric motor, the electrically connected member is fastened to the controller on an inner side of an inner circumferential surface of the stator.

9. The assembling method of the electric drive device according to claim 8, wherein the controller includes:
a conductive member; and
an intermediate member fastened to the electrically connected member and the conductive member,
in the fastening process, a first fastener is arranged along the axial direction of the electric motor, and the electrically connected member is fastened to the intermediate member along the axial direction of the electric motor by the first fastener, and
prior to the attaching process, a second fastener is arranged along the axial direction of the electric motor, and the conductive member is fastened to the intermediate member along the axial direction of the electric motor by the second fastener.

10. A wiring structure of an electric device, the wiring structure comprising:
a tubular member extending in an axial direction;
an electrically connected member electrically connected to the tubular member; and
a member to be fastened to the electrically connected member,
wherein, when the electric device is viewed in the axial direction, a fastening portion between the electrically connected member and the member to be fastened is arranged inside the electric device and does not overlap with the tubular member.
